(19) United States
(12) Patent Application Publication
(10) Pub. No.: US 2004/0201711 A1
(43) Pub. Date: Oct. 14, 2004

(54) Method for setting image intent

(76) Inventor: Patricia D. Lopaz, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/845,388

(22) Filed: Apr. 30, 2001

(51) Int. Cl. H04N 5/76

(52) U.S. Cl. 348/211.99

(57) ABSTRACT

An image intent file is created by a user or a trusted friend containing information about one or more of the common image destinations of the user. These destinations may include email addresses, web sites, local or networked printers, internet printing services, and I-frames (picture-like electronic displays with download capability). The possible image destinations included in the intent file are displayed graphically or textually on the display of the image capture device. For each image, the user is able to select one or more image destinations from the display of the image capture device. When the share function on the image capture device is activated, all images associated with each destination that are contained within the image capture device are sent to the destination with sufficient configuration data such that the destination correctly receives and processes the image or images.

### FIELD OF THE INVENTION

The present invention relates to the field of digital image acquisition, and more particularly, to the field of sharing digital images among users.

### BACKGROUND OF THE INVENTION

Users of digital cameras often have no problems taking photos, but encounter difficulties in sharing these photos with other people. Often, the photos must be downloaded to a computer, viewed and selected for sharing, and sent as an email attachment to a relative or friend, uploading to their personal web page, or an online photo processing service for the purchase of prints from the image. All of this manual work often stands in the way of a user desiring to share their images, but lacking the computer knowledge necessary to do so. There is a need in the art for an apparatus or method that enables users of digital image capture devices to easily select destinations for their images.

After capturing a number of images, on a camera or other image capture device, a user may edit the set of images, deleting any unwanted images while retaining the rest. After editing, the user may wish to have one (or more) copies made of each image. Currently many image capture devices require the user must manually transfer all of the images to a computer and select the destination printer or internet print service. There is a need in the art for an apparatus or method that enables users of digital image capture devices to easily select a printer or print service, the number and size of copies desired. Then, after selecting the users intent for the images, automatically send the images to the printer or print service with all instructions necessary to obtain the number and size of copies desired by the user.

### SUMMARY OF THE INVENTION

An image intent file is created by a user or a trusted friend containing information about one or more of the common image destinations of the user. These destinations may include email addresses, web sites, local or networked printers, internet printing services, and I-frames (picture-like electronic displays with download capability). The possible image destinations included in the intent file are displayed graphically or textually on the display of the image capture device. For each image, the user is able to select one or more image destinations from the display of the image capture device. When a share function on the image capture device is activated, all images associated with each destination that are contained within the image capture device are sent to the destination with sufficient configuration data such that the destination correctly receives and processes the image or images.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows the display of an image capture device incorporating the present invention.

FIG. 2 is an embodiment of an intent file according to the present invention.

FIG. 3 is a flowchart of a method for the sharing of digital images according to the present invention.

FIG. 4 is a block diagram of part of an image capture device incorporating the present invention.

### DETAILED DESCRIPTION

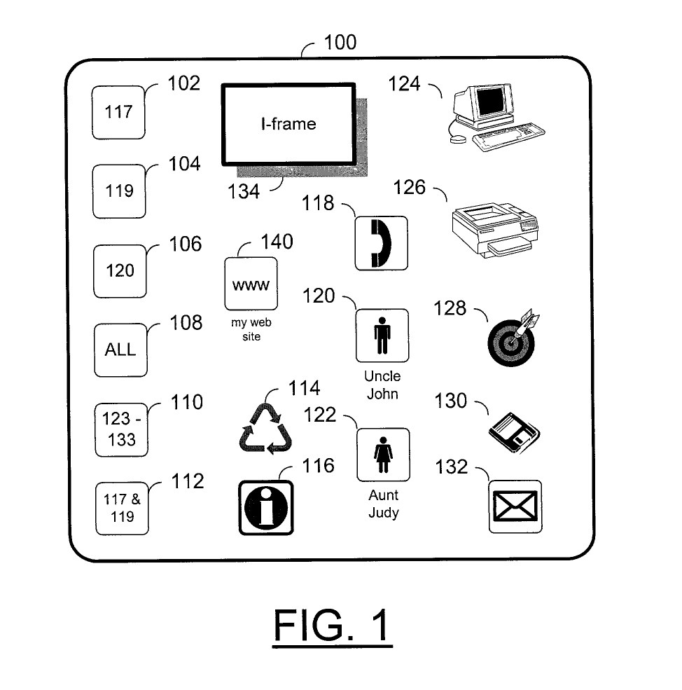

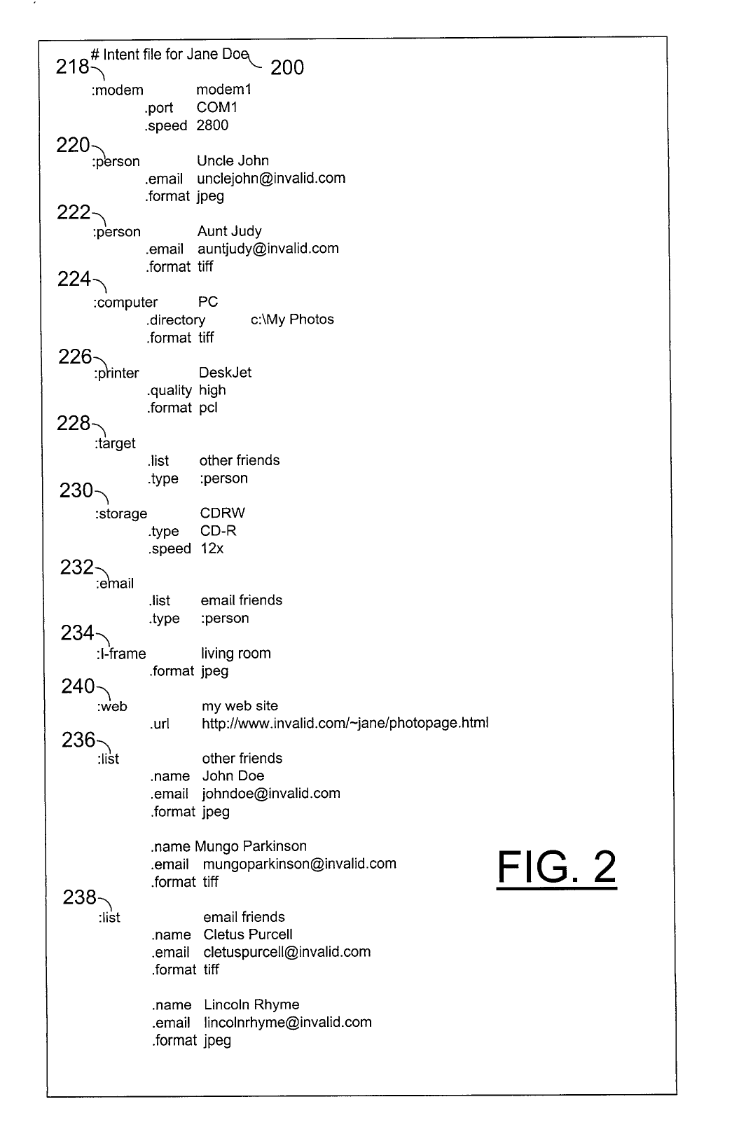

FIG. 1 shows the display of an image capture device incorporating the present invention. A display 100 incorporated into an image capture device may include a variety of icons or other representations of files and actions. In the example embodiment shown in FIG. 1 a number of icons representing files and actions are shown, but these files and actions may be represented textually within the scope of the present invention. In this example embodiment, photo 117 102 is represented by an icon. Likewise, photo 119 104, photo 120 106, photos 123 through 133 110, and photos 117 and 119 112 are all represented by icons. Also, all photos 108 in memory are represented by an additional single icon. A recycle icon 114 is available for deleting any photo or group of photos from the memory of the image capture device. An information icon 116 is available for displaying information such as size, date taken, and other data about any photo or group of photos. Additionally, a number of icons are present representing possible photo destinations as defined in an intent file. An example intent file corresponding to this example display is shown in FIG. 2. The icons in this example embodiment include a modem icon 118 so that a photo or group of photos may be transferred through a modem. Also present are icons to send an image to Uncle John 120, and one to send an image to Aunt Judy 122. (All the names contained in this document are fictional.) A computer icon 124 allows the user to download a photo or group of photos to a computer. The computer may be electrically coupled with the image capture device, or wireless communication techniques may be used to transfer the images. A printer icon 126 allows the user to send the photo or group of photos directly to a printer. A target icon 128 may allow the user to select a target device not shown on the display. A storage icon 130 may allow the user to save the photo or group of photos to an external storage device. An email icon 132 may allow the user to email the photo or group of photos to a person, a mailing list, or other email destination, such as an online photo processor. An I-frame icon 134 would allow a user to send an image or group of images to a picture-like electronic display with download capability (I-frame). Finally, a web page icon 140 would allow a user to automatically upload an image or group of images to a web page. All the destination icons shown (and others not shown) in the example embodiment of the present invention in FIG. 1 have corresponding entries in an intent file that is shown in FIG. 2.

FIG. 2 is an embodiment of an intent file according to the present invention. This example intent file contains example data such as might be used with the example icons present in FIG. 1. The syntax shown in FIG. 2 is one possible syntax, out of an immense variety that may be created for use with the present invention. The actual syntax and file format used by the intent file are not relevant to the functionality of the present invention. The first line of the example intent file of FIG. 2 is a comment line 200. The comment line 200 contains the text, “Intent file for Jane Doe” used in this example to identify the user of the intent file. A modem object 218 is shown in the example intent file with a name of “modem1” as shown in the first line of the modem object 218. This modem object 218 has a .port property of “COMI”, and a .speed property of 2800. A first person object 220 with a name of “Uncle John” is also shown in the example intent file. The first person object 220 has a .email property of unclejohn@invalid.com, representing the email address of Uncle John, and a format property of jpeg, representing the format the photos will be sent in. A second person object 222 with a name of “Aunt Judy” is also shown in the example intent file. The second person object 222 has a .email property of auntjudy@invalid.com, representing the email address of Aunt Judy, and a format property of tiff, representing the format the photos will be sent in. A computer object 224 with a name of “PC” is also shown in the example intent file. The computer object 224 has a directory property of “c:\My Photos”, representing the directory photos will be stored in, and a format property of tiff, representing the format that the photos will be stored in. A printer object 226 with a name of “DeskJet” is also shown in the example intent file. The printer object 226 has a quality property of “high”, representing the printing quality desired, and a format property of “pcl”, representing the data format to be sent to the printer. The printer object 226 may further contain properties similar to, but not limited to, those present in the Digital Print Order Format (DPOF) released by Canon, Inc., Eastman Kodak Company, Fuji Photo Film Co., Ltd., and Matsushita Electric Industrial Co., Ltd. on Jul. 17, 2000. A target object 228 without a name is also shown in the example intent file. This target object 228 includes a list property of “other friends”, representing the first list object 236 in the example intent file and a .type property of “:person”, representing the data type of the first list object 236. This target object 228 is one possible example of the use of hierarchy within an intent file. By the use of a single target icon 128, the user is able to have many more intents specified than may be displayed in one screen of the display 100. When the target icon 128 is selected, another screen is displayed containing the intents specified in the first list object 236 that the target object 228 references. In this case two more person icons would appear with the names of “John Doe” and “Mungo Parkinson.” A storage object 230 with the name of “CDRW” is also shown in the example intent file. The storage object 230 has a .type property of “CD-R”, representing the type of CDROM to be written, and a speed property of “12×”, representing the maximum speed of the CDROM drive. An email object 232 without a name is also shown in the example intent file. The email object 232 has a .list property of “email friends”, representing the second list object 238 in the example intent file, and a .type property of “:person”, representing the data type of the second list object 238. This email object 232 is another example of the use of hierarchy within an intent file. By the use of a single email icon 132, the user is able to have many more intents specified than may be displayed in one screen of the display 100. When the email icon 132 is selected, another screen is displayed containing the intents specified in the second list object 238 that the email object 232 references. In this case two more person icons would appear with the names of “Cletus Purcell” and “Lincoln Rhyme.” An I-frame object 234 with the name “living room” is also shown in the example intent file. The I-frame object 234 is used when the I-frame icon 134 is selected. This I-frame object 234 has a format property of jpeg, representing the data format of the images to be sent to the I-frame. A web page object 240 with the name “my web site” is also shown in the example intent file. The web page object 240 is used when the web page icon 140 is selected. This web page object 240 has a .url property of “http://www.invalid.com/˜jane/photopage.html,” representing the uniform resource locator (URL) of the web page that the image or images are to be uploaded to.

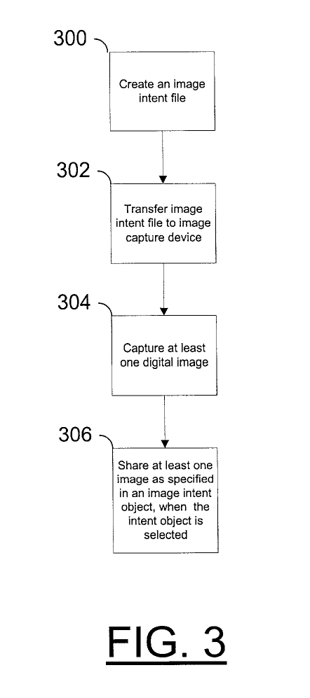

FIG. 3 is a flowchart of a method for the sharing of digital images according to the present invention. In a step 300 a user or their trusted friend creates an image intent file containing intent objects specifying the sharing parameters for the user. In a step 302 the image intent file is transferred to an image capture device. This transfer may take place through a cable, through infrared transmitter/receiver devices, through the manual transfer of removable memory cards, or any other method of transferring data from the device where the image intent file is created to the image capture device. The transfer step may be initiated in a wide variety of ways. The pushing of a share button by a user may initiate the transfer, or the simple connection of a cable between the image capture device and an external electronic device may initiate the transfer. Further, if transmitters and receivers are used for the transfer, the transfer may be initiated by bringing the transmitter and receiver within range. In other words, the transfer may be initiated when the proximity of the transmitter to the receiver crosses a proximity threshold, where the proximity threshold is set to a distance at which communication between the transmitter and receiver may occur. In a step 304 at least one digital image is captured by the image capture device. Note that this image capture step 304 may occur at any point in the process prior to the sharing step 306. In a step 306 when one or more intent objects are selected by the user, the image or images as specified in the image intent objects selected by the user are shared.

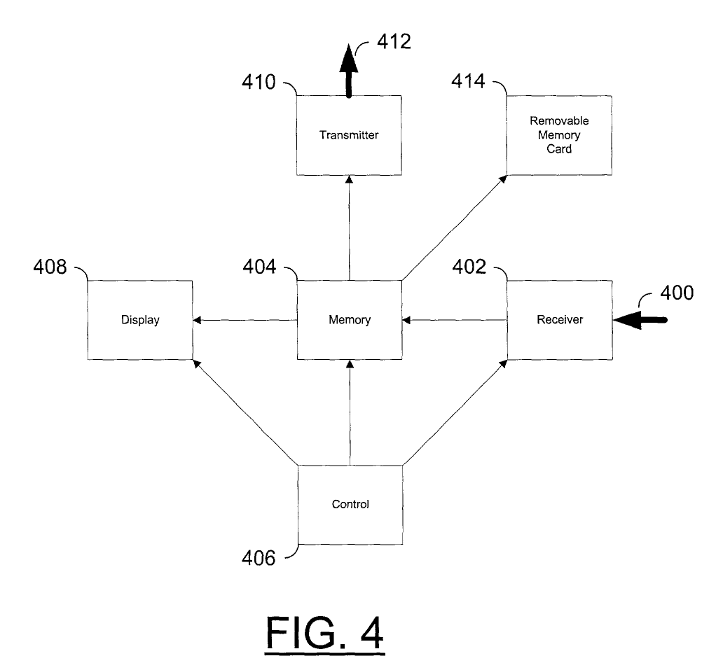

FIG. 4 is a block diagram of part of an image capture device incorporating the present invention. An intent file 400, such as that shown in FIG. 2 is received by the image capture device in a receiver block 402. The receiver block 402 then stores the intent file 400 in a memory 404. The memory block 404 is connected to a display 408 similar to that shown in FIG. 1 where icons representing intent objects are displayed. A control block 406 is used to control the receiver 402, memory 404, and display 408 blocks. The control block 406 also controls when the memory 404 transmits image and intent data 412 to a transmitter block 410 for transfer to a computer, printer, or other device. Note that the control block 406 may include buttons on the image capture device that allow the user to select between the several intent icons shown on the display 408. The transmitter 410 may send the data to an electronic device such as a computer, printer, or other device using a cable, or wireless technology. Likewise the receiver 402 may receive intent files from an electronic device through a cable, or with wireless technology. In some implementations, the receiver 402 and transmitter 410 may be combined in an input/output (I/O) block. Further, the receiver 402 and transmitter 410 may be activated by a wide variety of techniques, not limited to the control block 406. For example, in an example embodiment of the present invention, the receiver 402 or transmitter 410 may be configured to automatically begin data transfer when the image capture device comes within a specified distance of the electronic device they will communicate with. This distance need not be specified as a discrete distance, but in some embodiments may be set to a distance where the receiver 402 or transmitter 410 may reliable transfer data with the electronic device. In wireless technologies, this distance may be the point at which signal strength is sufficient to allow efficient data transfer between the devices. In some embodiments of the present invention, a removable memory card 414 may be used to transfer image and intent information from the image capture device to an electronic device such as a computer or printer.

An intent file, such as that shown in FIG. 2, may be created by a user of an image capture device, or a trusted friend with more computer skills. Once the intent file is created and downloaded to the image capture device, relatively unskilled users may select photos and share them with other people, send them to printers and other destinations without the knowledge of all the details that are needed to correctly specify these destinations. These intent files may be created on a computer, personal digital assistant (PDA), or other device capable of creating or editing intent, and downloaded to the image capture device through a cable or with the use of wireless technology (such as infrared transmitters and detectors). Some web sites may contain intent file objects allowing people browsing the web site to download the intent file objects and thus enabling the users to easily transmit images to the web site (or other location) without having to bother with the details of the configuration. Families may wish to create a web page containing intent file objects for each of the family members wanting to receive images. Further they may create intent file objects that enable the sharing of images with different groups of family members each via a single intent file object.

Businesses may also take advantage of portability of these intent file objects and provide intent file objects for transmitting images to be printed directly to the business. Further, printer manufacturers may wish to make available intent file objects optimized for best results in printing to their different models of printers. Computer storage device manufacturers may likewise make optimized intent file objects publicly available for their different models.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for the sharing of digital images comprising the steps of:
a) creating an image intent file;
b) transferring said image intent file to an image capture device;
c) capturing a digital image; and
d) sharing said digital image as specified in said image intent file when at least one intent object has been selected from said image intent file.

2. A method for the sharing of digital images as recited in claim 1, wherein said transferring step uses at least one infrared transmitter and at least one infrared receiver.

3. A method for the sharing of digital images as recited in claim 2, wherein said transferring step is initiated by the proximity of said infrared transmitter to said infrared receiver crossing a proximity threshold.

4. A method for the sharing of digital images as recited in claim 1, wherein said intent file is created or edited on an electronic device.

5. A method for the sharing of digital images as recited in claim 1, wherein said sharing step includes downloading said digital image to a computer from said image capture device using wireless technology.

6. A method for the sharing of digital images as recited in claim 5, wherein said sharing step is initiated by the proximity of said image capture device to said computer crossing a proximity threshold.

7. A method for the sharing of digital images as recited in claim 5, wherein said sharing step is initiated by said computer.

8. A method for the sharing of digital images as recited in claim 1, wherein said sharing step includes downloading image and intent information from said image capture device to an electronic device through a cable.

9. A method for the sharing of digital images as recited in claim 8, wherein said sharing step is initiated by the connection of said cable between said image capture device and said electronic device.

10. A method for the sharing of digital images as recited in claim 8, wherein said sharing step is initiated by said electronic device.

11. A method for the sharing of digital images as recited in claim 1, wherein said sharing step includes downloading image and intent information from said image capture device using a removable memory card.

12. A method for the sharing of digital images as recited in claim 11, wherein said sharing step is initiated by the insertion of said removable memory card.

13. An image capture system as recited in claim 1, wherein said image intent file contains at least one modem object.

14. An image capture system as recited in claim 1, wherein said image intent file contains at least one person object.

15. An image capture system as recited in claim 1, wherein said image intent file contains at least one computer object.

16. An image capture system as recited in claim 1, wherein said image intent file contains at least one printer object.

17. An image capture system as recited in claim 1, wherein said image intent file contains at least one target object.

18. An image capture system as recited in claim 1, wherein said image intent file contains at least one storage object.

19. An image capture system as recited in claim 1, wherein said image intent file contains at least one email object.

20. An image capture system as recited in claim 1, wherein said image intent file contains at least one I-frame object.

21. An image capture system as recited in claim 1, wherein said image intent file contains at least one web page object.

22. An image capture system comprising:
a memory;
a receiver coupled with said memory capable of receiving an image intent file;
a display coupled with said memory capable of displaying objects contained within said image intent file; and
at least one control coupled with said display and said memory allowing the selection of at least one of said displayed objects from said display.

23. An image capture system as recited in claim 22, further comprising:
a removable memory coupled with said memory and said control, capable of storing at least one image and at least one of said objects.

24. An image capture system as recited in claim 22, further comprising:
a transmitter coupled with said memory and said at least one control, capable of transmitting at least one image and at least one of said objects to an electronic device.

25. An image capture system as recited in claim 24, wherein said transmitter is activated to begin transmitting said at least one image and said at least one of said objects by the proximity of said image capture system to said electronic device crossing a proximity threshold.

26. An image capture system as recited in claim 24, wherein said transmitter is an infrared transmitter.

27. An image capture system as recited in claim 26, wherein said transmitter is activated to begin transmitting said at least one image and said at least one of said objects by the proximity of said infrared transmitter to an infrared receiver within said electronic device crossing a proximity threshold.

28. An image capture system as recited in claim 22, wherein said image intent file contains at least one modem object.

29. An image capture system as recited in claim 22, wherein said image intent file contains at least one person object.

30. An image capture system as recited in claim 22, wherein said image intent file contains at least one computer object.

31. An image capture system as recited in claim 22, wherein said image intent file contains at least one printer object.

32. An image capture system as recited in claim 22, wherein said image intent file contains at least one target object.

33. An image capture system as recited in claim 22, wherein said image intent file contains at least one storage object.

34. An image capture system as recited in claim 22, wherein said image intent file contains at least one email object.

35. An image capture system as recited in claim 22, wherein said image intent file contains at least one I-frame object.

36. An image capture system as recited in claim 22, wherein said image intent file contains at least one web page object.

37. An image capture system comprising:
means for creating an image intent file;
means for transferring said image intent file to an image capture device;
means for capturing a digital image; and
means for sharing said digital image as specified in said intent file when at least one intent object has been selected from said image intent file.

38. An image capture system as recited in claim 37, wherein said means for transferring uses at least one infrared transmitter and at least one infrared receiver.

39. An image capture system as recited in claim 38, wherein said means for transferring is activated by the proximity of said infrared transmitter to said infrared receiver crossing a proximity threshold.

40. An image capture system as recited in claim 37, wherein said means for sharing includes downloading said digital image to a computer from said image capture device using wireless technology.

41. An image capture system as recited in claim 40, wherein said means for sharing is activated by the proximity of said image capture device to said computer crossing a proximity threshold.

42. An image capture system as recited in claim 40, wherein said means for sharing is activated by said computer.

43. An image capture system as recited in claim 37, wherein said means for sharing includes downloading image and intent information from said image capture device to an electronic device through a cable.

44. An image capture system as recited in claim 43, wherein said means for sharing is activated by the connection of said cable between said image capture device and said electronic device.

45. An image capture system as recited in claim 43, wherein said means for sharing is activated by said electronic device.

46. An image capture system as recited in claim 37, wherein said means for sharing includes downloading image and intent information from said image capture device using a removable memory card.

47. An image capture system as recited in claim 46, wherein said means for sharing is activated by the insertion of said removable memory card.
